(19) United States
(12) Patent Application Publication
(10) Pub. No.: US 2018/0350253 A1
(43) Pub. Date: Dec. 6, 2018

(54) BIG DATA BASED LANGUAGE LEARNING DEVICE AND METHOD FOR LEARNING LANGUAGE USING THE SAME

(71) Applicant: Woorirang Korea, Inc., Seoul (KR)

(72) Inventor: JungHwa Nam, Seoul (KR)

(21) Appl. No.: 15/978,047

(22) Filed: May 11, 2018

(30) Foreign Application Priority Data
May 30, 2017 (KR) 10-2017-0066715

(51) Int. Cl. G09B 7/04; G09B 19/06; G06F 17/28; G06F 17/27

(52) U.S. Cl. CPC G09B 7/04; G06F 17/274; G06F 17/2845; G09B 19/06

(57) ABSTRACT

Disclosed herein are a big data based language learning device and a method for learning a language using the same. The big data based language learning device includes: a database of a server computer in which sentences in a natural language are stored, the sentences consisting of ones having a grammatical error and ones having no grammatical error; a quiz module configured to receive a grammar type and/or a subject that a user wants to study from an input device that are connected a user device either wired or wireless, or that are built into the user device, and the quiz module further configured to receive a sentence among the sentences in the natural language stored in the database, the sentence corresponds to the received grammar type and/or the subject, the sentence includes the grammatical error, and the quiz module further configured to issue the sentence as a quiz on a display of the user device; an answer sheet module configured to receive an answer to the quiz from the input device of the user device; a sentence among the sentences in the natural language stored in the database of the server computer, the sentence corresponds to the received grammar type and/or the subject and the sentence includes no grammatical error, the correction module further configured to compare the answer with the sentence including no grammatical error, and the correction module further configured to correct an error in the answer; and a learning module configured to update the database of the server computer with a training pattern consisting of the answer, a rate of correct answer for the grammar type and/or the subject, a difficulty level and an incorrect answer pattern, wherein the quiz module outputs a next quiz based on the training pattern updated in the database by the learning module and wherein the input device comprises at least one of a mouse, a touch pad, a touch screen, a keyboard, a handwriting recognizer, and a microphone.

### CROSS-REFERENCE TO RELATED APPLICATIONS

This application claims the priority of Korean Patent Application No.10-2017-0066715 filed on May 30, 2017, in the Korean Intellectual Property Office, the disclosure of which is incorporated herein by reference.

### BACKGROUND

### Technical Field

The present disclosure relates to a big data based language learning device and a method for learning a language using the same. More particularly, the present disclosure relates to a big data based language learning device that allows a user to learn a language more efficiently based on the user's learning goal and training pattern, and a method for learning a language using the same.

### Description of the Related Art

When people learn a new language, they expect to speak it fluently someday. To do so, people start with studying very basic letters and pronunciations. There are many ways to learn a language: people may take lessons, go abroad, listen to broadcasts, etc. Unfortunately, it takes money and time to take lessons or go abroad. Accordingly, people are looking for effective ways to learn a language which are not costly and time-consuming. One of such effective ways is writing.

When a learner studies a language by writing, it takes less money and time than taking lessons or going abroad. In addition, the learner can apply the principles she/he has studied to the real situations and can check if she/he understood the principles correctly.

However, when a learner writes a sentence based on a grammar she/he newly studied, the sentence is very likely to have a grammatical error, and it is difficult for the learner to find such an error by herself/himself . Even if there is an educator to teach the learner, it is difficult for the educator to correct grammatical errors in real time. Accordingly, it takes a lot of time to develop language fluency. Therefore, in case that it is difficult to correct an error of the sentence written by the learner in real time, studying a language by writing may be an inefficient way to learn the language.

### SUMMARY

In view of the above, an object of the present disclosure is to provide a big data based language learning device and a method for learning a language using the same that can provide a user with customized language learning based on the user's learning goal and training pattern.

Another object of the present disclosure is to provide a big data based language learning device and a method for learning a language using the same that can provide a user with a base form, variation examples and usage examples used in the real life as well as grammatical knowledge, so that the user can study the language to an expanded range.

It should be noted that objects of the present disclosure are not limited to the above-described objects, and other objects of the present disclosure will be apparent to those skilled in the art from the following descriptions.

According to an aspect of the present disclosure, there is provided a big data based language learning device including: a database of a server computer in which sentences in a natural language are stored, the sentences consisting of ones having a grammatical error and ones having no grammatical error; a quiz module configured to receive a grammar type and/or a subject that a user wants to study from an input device that are connected a user device either wired or wireless, or that are built into the user device, and the quiz module further configured to receive a sentence among the sentences in the natural language stored in the database, the sentence corresponds to the received grammar type and/or the subject, the sentence includes the grammatical error, and the quiz module further configured to issue the sentence as a quiz on a display of the user device; an answer sheet module configured to receive an answer to the quiz from the input device of the user device; a sentence among the sentences in the natural language stored in the database of the server computer, the sentence corresponds to the received grammar type and/or the subject and the sentence includes no grammatical error, the correction module further configured to compare the answer with the sentence including no grammatical error, and the correction module further configured to correct an error in the answer; and a learning module configured to update the database of the server computer with a training pattern consisting of the answer, a rate of correct answer for the grammar type and/or the subject, a difficulty level and an incorrect answer pattern, wherein the quiz module outputs a next quiz based on the training pattern updated in the database by the learning module and wherein the input device comprises at least one of a mouse, a touch pad, a touch screen, a keyboard, a handwriting recognizer, and a microphone.

Sentences in the natural language stored in the database may further include at least one of variations of a declarative sentence, interrogative sentence, imperative sentence, exclamatory sentence, negative expression, formal expression, tense, aspect, passive voice and active voice.

The quiz module may receive the grammar type and/or subject from the input device of the user device by using letters that are entered by the keyboard or the handwriting recognizer, by using voice that is entered by the microphone, and/or by selecting a category that is selected by the mouse, the touch pad or the touch screen, may provide the grammar type and/or the subject from the user device to the server computer, and may issue the quiz belonging to the received grammar type and/or subject.

The answer sheet module may receive the answer to the quiz from the user device by using letters that are entered by the keyboard or the handwriting recognizer or by using voice that is entered by the microphone, and may provide the answer to the correction module.

The correction module may receive a sentence among the sentences in the natural language stored in the database of the server computer, the sentence corresponds to the grammar type and/or the subject and the sentence has no grammatical error, the correction module may store the sentence as a correct answer, may compare the answer with the correct answer, and may correct the grammatical error in the answer, if any, to output a correct answer, and the correct module may further output at least one of variations of a declarative sentence, an interrogative sentence, an imperative sentence, an exclamatory sentence, a negative expression, a formal expression, tense, aspect, passive voice and active voice of the correct answer, and a grammatical knowledge that is basis of the correct answer, together with the correct answer.

The server computer may update the database with usage examples of the correct answer used in real life such as the Internet or broadcast media received from another server computer, the correction module may further output usage examples of the correct answer used in a real life such as the Internet or broadcast media, and the usage examples may include colloquial expressions, newly coined words, jargons, Internet slangs, buzzwords and foreign words of the correct answer.

If the answer is incorrect, the learning module may classify the answer into a sentence in the natural language having the grammatical error to update the database of the server computer with it, the learning module may update the database of the server computer with individual training pattern based on the user's answer and results from the correction module, the individual training pattern comprising the answer, the rate of correct answers for the grammar type and/or subject, the average difficulty level and the incorrect answer pattern together with the user identification information.

If the user identification information is received in the quiz module through the input device of the user device, the quiz module may receive the individual training pattern updated in the database of the server computer, the quiz module may issue the quiz by reflecting the grammar type and/or subject of the difficulty level set by the user based on the individual training pattern updated in the database of the server computer, and the user identification information comprises at least one of the user's names, telephone numbers, IDs, fingerprints, iris, vein, voice and facial feature.

The learning module may receive an individual training pattern of each of users from the database of the server computer, may generate a whole training pattern consisting of an average rate of correct answers for the grammar type and/or the subject, an average difficulty level and an average incorrect answer pattern based on an individual training pattern of each of users, and may update the database of server computer with a whole training pattern consisting of an average rate of correct answers for the grammar type and/or subject, an average difficulty level and an average incorrect answer pattern based on an individual training pattern.

If no user identification information is received in the quiz module through the input device of the user device, the quiz module may receive the whole training pattern updated in the database of the server computer, and may issue the quiz by reflecting the grammar type and/or subject of the average difficulty level corresponding to a difficulty level set by a user based on the whole training pattern updated in the database.

According to another aspect of the present disclosure, there is provided a method for learning a language based on big data, including: receiving a grammar type and/or subject that a user wants to study from a input device of a user device; issuing as a quiz a sentence among sentences in a natural language stored in a database of a server computer that belongs to the grammar type and/or subject and has an grammatical error; receiving an answer to the quiz from the user through the input device of the user device; correcting an error in the answer based on a sentence among sentences in a natural language stored in the database of the server computer, the sentence corresponds to the quiz and has no grammatical error; and updating the database of the server computer with a training pattern consisting of the answer, a rate of correct answer for the grammar type and/or the subject, a difficulty level and an incorrect answer pattern, wherein the issuing the quiz comprises issuing a next quiz based on the training pattern updated in the database.

The details of one or more embodiments of the subject matter described in this specification are set forth in the accompanying drawings and the description below.

According to an exemplary embodiment of the present disclosure, a user can be provided with customized language learning based on the user's learning goal and training pattern, so that the user can learn the language efficiently.

According to another exemplary embodiment of the present disclosure, a user can be provided with a base form, variation examples and usage examples used in the real life as well as grammatical knowledge, so that the user can study the language to an expanded range.

It should be noted that effects of the present disclosure are not limited to those described above and other effects of the present disclosure will be apparent to those skilled in the art from the following descriptions.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1A is a diagram for illustrating a relationship between a big data-based language learning server and a user device according to an exemplary embodiment of the present disclosure;

FIG. 1B is a block diagram of a big data-based language learning device according to an exemplary embodiment of the present disclosure;

FIG. 1C is a block diagram of a big data-based language learning device driven by a processor according to an exemplary embodiment of the present disclosure;

FIG. 2 is a diagram illustrating an example of the screen in which a big data based language learning device according to an exemplary embodiment of the present disclosure is displayed;

FIG. 3 is a flowchart for illustrating a method for learning language using a big data-based language learning apparatus according to an exemplary embodiment of the present disclosure;

FIG. 4A is a diagram showing an example of the screen in which a quiz module of a big data based language learning device according to an exemplary embodiment of the present disclosure receives a grammar type that a user wants to study from a user device and issues a quiz;

FIG. 4B is a diagram showing an example of the screen in which a quiz module of a big data based language learning device according to an exemplary embodiment of the present disclosure receives a subject that a user wants to study from a user device and issues a quiz;

FIG. 4C is a diagram showing an example of the screen in which a quiz module of a big data based language learning device according to an exemplary embodiment of the present disclosure receives a grammar type and a subject that a user wants to study from a user device and issues a quiz;

FIG. 5 is a diagram illustrating an example of the screen in which an answer sheet module of a big data based language learning device according to an exemplary embodiment of the present disclosure receives an answer;

FIG. 6 is a diagram illustrating an example of the screen in which a correction module of a big data based language learning device according to an exemplary embodiment of the present disclosure corrects an error in an answer and outputs a correct answer, grammar knowledge and variations;

FIG. 7 is a diagram for illustrating a process of updating the database with training patterns by a learning module of a big data based language learning device according to an exemplary embodiment of the present disclosure;

FIG. 8 is a diagram showing an example of the screen in which a quiz module of a big data-based language learning apparatus according to an exemplary embodiment of the present disclosure, issues a quiz based on a user's identification information and individual training pattern;

FIG. 9 is a diagram showing an example of the screen in which a quiz module of a big data based language learning device according to another exemplary embodiment of the present disclosure issues a quiz based on a whole training pattern; and

FIG. 10 is a diagram illustrating an example of the screen in which a correction module of a big data based language learning device according to yet another exemplary embodiment of the present disclosure corrects an error in an answer and outputs a correct answer, grammar knowledge, variations and examples.

### DETAILED DESCRIPTION OF THE PREFERRED EMBODIMENT

Advantages and features of the present disclosure and methods to achieve them will become apparent from the descriptions of exemplary embodiments hereinbelow with reference to the accompanying drawings. However, the present disclosure is not limited to exemplary embodiments disclosed herein but may be implemented in various different ways. The exemplary embodiments are provided for making the disclosure of the present disclosure thorough and for fully conveying the scope of the present disclosure to those skilled in the art. It is to be noted that the scope of the present disclosure is defined only by the claims.

Although terms such as first, second, etc. are used to distinguish arbitrarily between the elements such terms describe, and thus these terms are not necessarily intended to indicate temporal or other prioritization of such elements. Theses terms are used to merely distinguish one element from another. Accordingly, as used herein, a first element maybe a second element within the technical scope of the present disclosure.

Like reference numerals denote like elements throughout the descriptions.

Features of various exemplary embodiments of the present disclosure may be combined partially or totally. As will be clearly appreciated by those skilled in the art, technically various interactions and operations are possible. Various exemplary embodiments can be practiced individually or in combination.

Hereinafter, exemplary embodiments of the present disclosure will be described in detail with reference to the accompanying drawings.

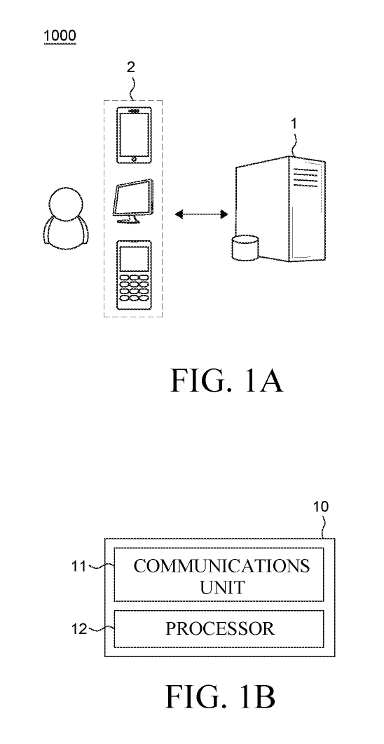

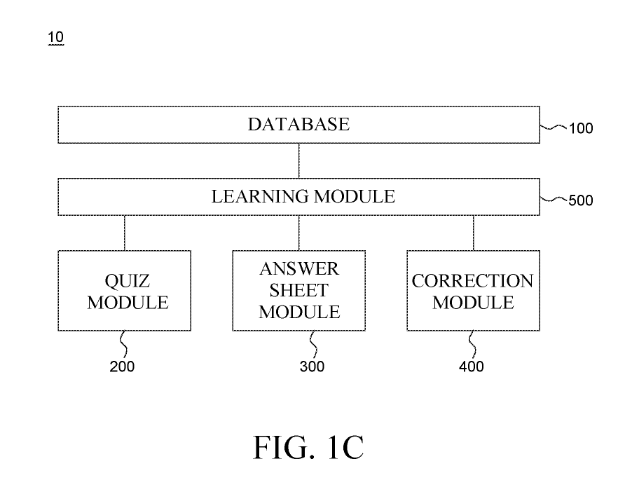

FIG. 1A is a diagram for illustrating a relationship between a big data based language learning server and a user device according to an exemplary embodiment of the present disclosure.

In the following description, it is assumed that a user is a learner who learns a language by using a big data based language learning system.

Referring to FIG. 1A, a big data based language learning system 1000 includes a big data based language learning server 1 and a user device 2.

The big data based language learning system 1000 can provide a big data language learning method capable of providing customized language learning based on a user's learning goal and training pattern.

The big data based language learning server 1 receives a grammar type and/or a subject the user wants to study from the user device 2, and sends back a quiz associated with the received grammar type and/or subject to the user device 2.

Then, the big data based language learning server 1 receives an answer to the quiz from the user device 2, corrects an error in the answer, and sends the correct answer to the quiz to the user device 2.

The big data based language learning server 1 may determine the user' s training pattern using the user device 2, and may send a quiz to the user device 2 based on the user's training pattern upon receiving a grammar type and/or subject that the user wants to study.

The big data based language learning server 1 and the user device 2 may be disposed in the same network or may be connected to each other to thereby perform a method for learning a language using a big dada-based language learning device. The configuration and function of the big data based language learning server 1 will be described in detail later with reference to FIG. 1B.

The big data based language learning server 1 may be a co-location server or a cloud server, and may be a server or a device included in such a server. For example, the big data based language learning server 1 may be a server computer. It is, however, to be understood that the present disclosure is not limited thereto. The big data based language learning server 1 may be implemented as any of a variety of well known devices. In the following description, it is assumed that the big data based language learning server 1 is a server computer.

The user device 2 may be a communications terminal capable of using a web or mobile service in a wired/wireless communication environment. Specifically, the user device 2 may be a user's computer or a user's portable terminal. Although the user device 2 is shown as a smartphone or a computer in FIG. 1A, the present disclosure is not limited thereto. The type of the user device 2 is not particularly limited as long as it can communicate with the big data based language learning server, and a program can be installed in the user device 2 which allows the user device 2 to provide quizzes for learning a language, answers to the quizzes and grammar knowledge based on the data received from the big data based language learning server.

The user device 2 may include a display for displaying images, and an input device for receiving data from a user. The input device of the user device 2 may be a mouse, a touch pad, a touch screen, a keyboard, a handwriting recognizer, or a microphone. The input device is connected the user device 2 either wired or wireless, or that are built into the user device 2.

Although FIG. 1A shows only one big data based language learning server 1 and one user device 2 for convenience of illustration, the present disclosure is not limited thereto. More than one big data based language learning servers 1 and more than one user devices 2 may be provided and may communicate with one another.

Hereinafter, the configurations of the big data based language learning server 1 and the user device 2 in the big data based language learning system 1000 will be described. A more detailed description will be made with reference to FIG. 1B.

FIG. 1B is a block diagram of a big data based language learning device according to an exemplary embodiment of the present disclosure.

The big data based language learning device 10 is included in the big data based language learning server 1 or connected to the big data based language learning server 1, to perform the method for learning a language using the big data based language learning device 10.

Referring to FIG. 1B, the big data based language learning device 10 includes a communications unit 11 and a processor 12.

The big data based language learning device 10 transmits/receives data and contents for performing the method for learning a language to/from the user device 2.

Specifically, the communications unit 11 receives a grammar type and/or a subject that the user wants to study from the user device 2, and sends back a quiz associated with the received grammar type and/or subject to the user device 2. The communications unit 11 receives answers to quizzes from the user device 2. In addition, the communications unit 11 also provides the user device 2 with grammar knowledge and correct answers for the received answers.

The processor 12 of the big data based language learning device 10 processes various data for performing the method for learning a language using the big data based language learning device 10.

Specifically, the processor 12 determines a quiz to be sent to the user device 2 from among sentences in the natural language that belongs to the grammar type and/or subject received from the user device 2 by the communications unit 11 and has an error based on the user's training pattern or the difficulty level.

In addition, the processor 12 may determine whether the answer to the quiz received by the communications unit 11 from the user device 2 coincides with the correct answer. Otherwise, the processor 12 may correct an error of the answer, if any. In addition, once the processor 12 has corrected the error of the answer, the error of the answer, the correct answer and the grammar knowledge which is the basis of the answer, and examples may be sent to the user device 2 through the communications unit 11.

In addition, the processor 12 may provide a platform in which data and contents for performing the method for learning a language according to an exemplary embodiment of the present disclosure are displayed in the display unit of the user device 2.

The big data based language learning device 10 may be at least one processor 12 or may include at least one processor 12. Accordingly, the big data based language learning device 10 may be included in another hardware device such as the microprocessor or a general-purpose computer system, or may be implemented as a separate device.

Although the communications unit 11 and the processor 12 have been described as being included in the big data based language learning device 10, the present disclosure is not limited thereto. The communication unit 11 and the processor 12 may be separately disposed outside the big data based language learning device 10 as long as the big data based language learning device 10 can perform the above-described functions. In addition, the big data based language learning device 10 may further include a storage unit.

In the following description, for convenience of illustration, it is assumed that the user device 2 is a smartphone, and the big data based language learning device 10 is implemented as an application is stored in a storage medium of the smartphone to be run by the processor 12 of the smartphone.

FIG. 1C is a block diagram of a big data-based language learning device driven by a processor according to an exemplary embodiment of the present disclosure.

Referring to FIG. 1C, a big data based language learning device 10 according to an exemplary embodiment of the present disclosure includes a database 100, a quiz module 200, an answer sheet module 300, a correction module 400, and a learning module 500.

In the database 100, sentences in natural languages with or without grammatical errors are stored in association with subjects, grammars, and the like. A natural language refers to a language used for communications in everyday life. There are many kinds and ranges of languages for many countries, such as Korean, English and Spanish.

A sentence in a natural language without grammatical errors refers to a correct sentence in terms of spelling, vocabulary, and grammar. For example, sentences such as “hello,” “nice to meet you,” “good morning” and “how are you?” are grammatically correct in terms of spacing of words, spelling, prepositions, ending of words and tense. Accordingly, the sentences can be provided to the user as correct answers.

On the other hand, a sentence in the natural language with grammatical errors refers to an incorrect sentence in terms of spelling, vocabulary, and grammar. For example, sentences such as “helo,” “how aa you” and “nice to meey you,” are grammatically incorrect in terms of spacing of words, spelling, prepositions, ending of words and tense. Accordingly, the sentences can be provided to the user as quizzes and may be stored in the database 100 in association with the sentences without grammatical errors, i.e., correct answers.

In addition, sentences in the natural language stored in the database 100 may further include at least one of variations of a declarative sentence, interrogative sentence, imperative sentence, exclamatory sentence, negative expression, formal expression, tense, aspect, passive voice and active voice. For example, the sentence in the natural language “hello” maybe stored in the database 100 together with variations such as “hi,” “good morning” and “nice to meet you.”

Specifically, a sentence in a natural language may include a sentence in the natural language with a grammatical error, i.e., a quiz, a sentence in the natural language without grammatical error associated with it, i.e., a correct answer, and the grammar, the subject, the grammar knowledge, variations, and examples. In addition, various information may be stored in association with the sentence in the natural language, and the present disclosure is not limited thereto.

The database 100 may be stored in a server computer. As described above with reference to FIG. 1B, the big data based language learning device 10 including the database 100 is included in the big data base language learning server 1, to perform the method for learning a language. In addition, the big data base language learning server 1 may be a server computer. Therefore, the database 100 may be stored in the server computer.

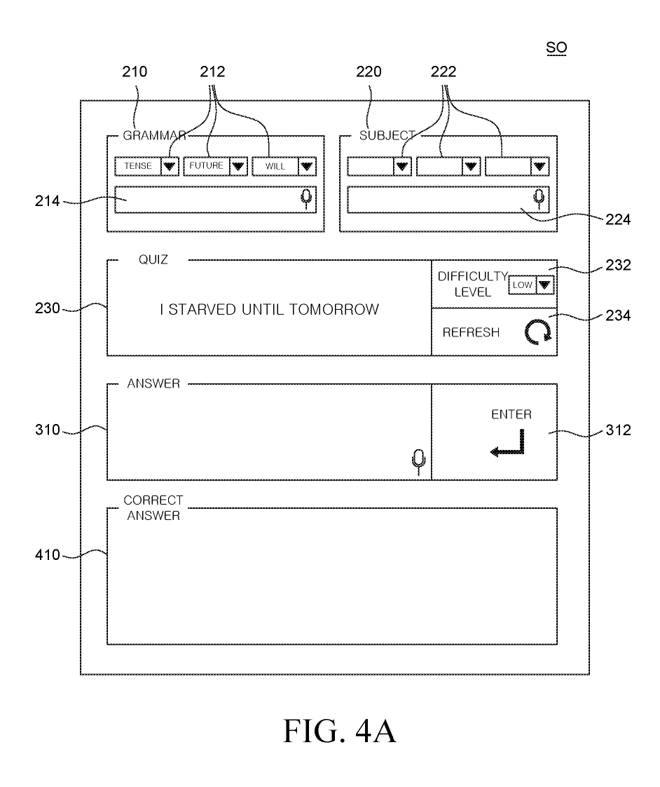

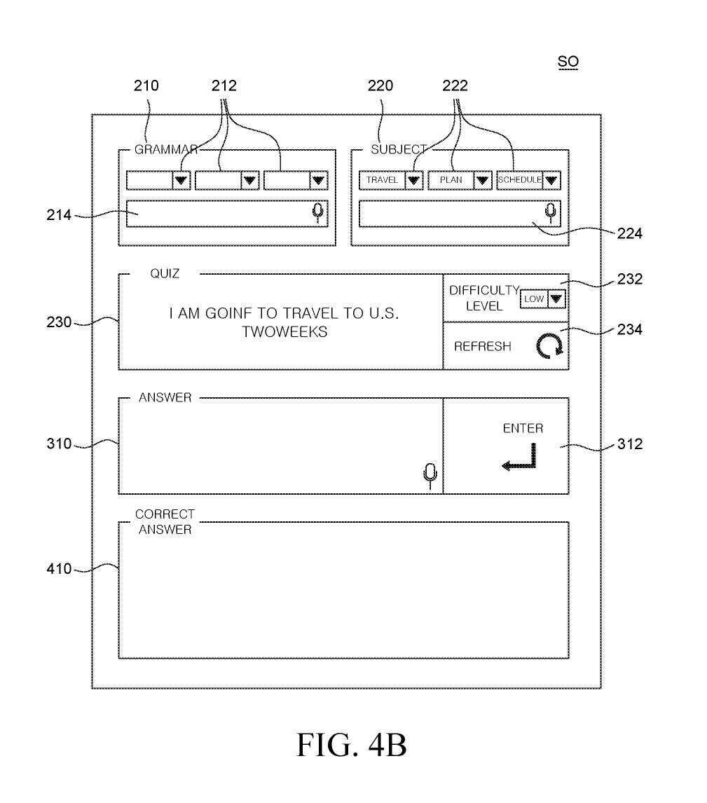

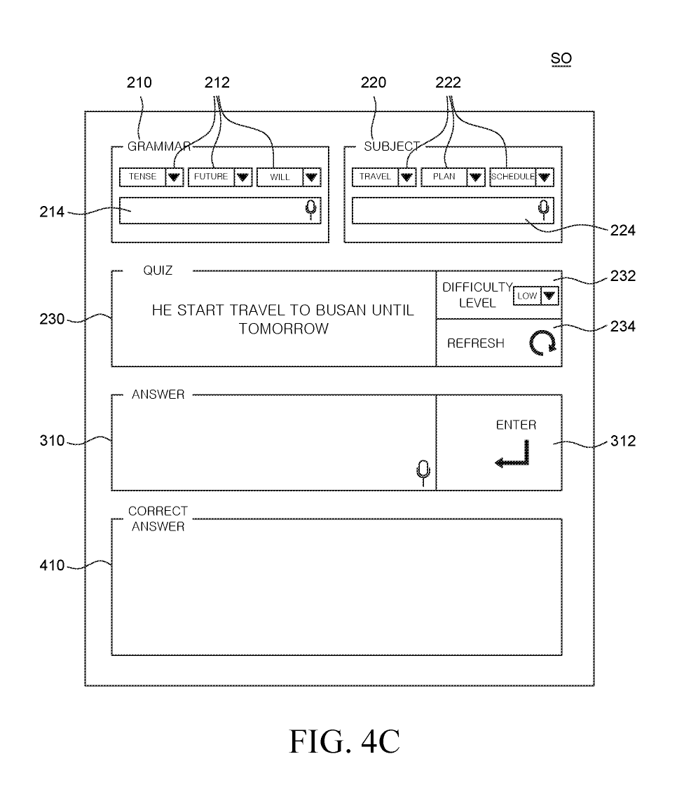

The quiz module 200 receives a grammar type and/or subject that the user wants to study from the input device of the user device 2. The quiz module 200 provides the grammar type and/or the subject to the server computer. The quiz module 200 issues a sentence in the natural language among the sentences stored in the database 100 of the server computer as a quiz on a display of the user device 2. The sentence corresponds to the received grammar type and/or the subject, and the sentence includes the grammatical error. The process that the quiz module 200 issues a quiz according to a grammar type and/or a subject will be described later with reference to FIGS. 4A to 4C.

The answer sheet module 300 receives answers to the quizzes from the input device of the user device 2. Specifically, when a user chooses a grammar type and/or a subject that she/he wants to study by using the user device 2, the quiz module 200 issues a sentence in the natural language which belongs to the grammar type and/or subject and has a grammatical error. The user may find the error in the quiz and correct the sentence to input a sentence in the natural language without a grammatical error by using the user device 2.

The correction module 400 corrects an error in the answer, if any. Specifically, the correction module 400 receives a sentence among the sentences in the natural language stored in the database 100 of the server computer, the sentence corresponds to the received grammar type and/or the subject and the sentence includes no grammatical error. The correction module 400 compares the answer that the user has input with the sentence without the error which has been stored in association with the sentence issued as the quiz, i.e., the correct answer. If the answer does not coincide with the correct answer, the answer may be corrected based on the correct answer. The correction module 400 may also provide a reason for the error.

The learning module 500 updates the database 100 of the server computer with the training pattern consisting of correct answers, correct answer rates for each of grammar types and/or subjects, difficulty level and incorrect answer pattern. Specifically, when the quiz module 200 issues a quiz belonging to a grammar type and/or a subject, the user inputs an answer through the user device 2, and the correction module 400 compares the answer with the correct answer, to correct the error. Then, the learning module 500 may determine from the correction results, a user's training pattern consisting of the user's correct answer rate for the grammar type and/or subject, the difficulty level depending on the average correct answer rate, and an incorrect pattern, and may update the database 100 of the server computer with the training pattern.

Then, the quiz module 200 may output the next quiz based on the updated training pattern stored in the database 100 of the server computer by the learning module 500. After the training pattern is updated by the learning module 500, when the quiz module 200 receives a new grammar type and/or subject that the user wants to study through the user device 2 and issues a quiz, the quiz may be output based on the grammar type and/or subject with a low rate of correct answers of the user by reflecting the training pattern.

Although the elements of the big data based language learning device 10 are depicted as separated elements for convenience of illustration, the elements may be implemented as a single element or each of the elements may be separated into two or more elements depending on implementations.

Hereinafter, an example of the screen in which the big data based language learning device 10 is displayed to a user will be described based on the above-described big data based language learning device 10 according to the exemplary embodiment of the present disclosure.

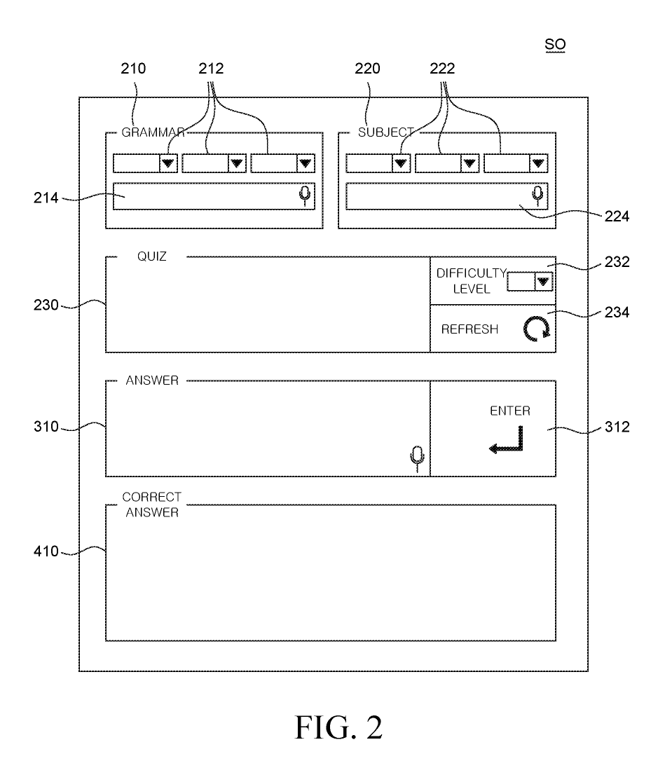

FIG. 2 is a diagram illustrating an example of the screen in which a big data based language learning device according to an exemplary embodiment of the present disclosure is displayed.

Referring to FIGS. 1A to 1C and 2, an output screen SO of an application in which the big data based language learning device 10 is displayed may include a grammar menu 210, a subject menu 220, a quiz output window 230, an answer input window 310, and a correct answer output window 410.

First, the quiz module 200 may receive a grammar type and/or subject from the user device 2 by using letters, voice and a category, and may issue a quiz belonging to the received grammar type and/or subject.

The quiz module 200 displayed to the user may include the grammar menu 210, the subject menu 220 and the quiz output window 230. The quiz module 200 may receive the grammar type and/or subject that the user wants to study through the grammar menu 210 and the subject menu 220. The user may choose a grammar type and/or subject that she/he wants to study at least one of by using letters, voice and a category.

When the user uses letters, the user may use an input device such as a keyboard and a handwriting recognizer to input the grammar type and/or subject in the form of letters to the grammar input window 214 of the grammar menu 210 and the subject input window 224 of the subject menu 220.

When the user uses voice, the user may use an input device such as a microphone to input the grammar type and/or subject in the form of voice to the grammar input window 214 of the grammar menu 210 and the subject input window 224 of the subject menu 220.

When the user selects a category, the user may use an input device such as a mouse, a touch pad and touch screen to select the grammar type and/or subject from the grammar categories 212 of the grammar menu 210 and the subject categories 222 of the subject menu 220.

The grammar categories 212 of the grammar menu 210 divide the grammar type into several parts. For example, the categories may be divided by linguistics such as phonology, morphology, syntax, semantics, and pragmatics. Alternatively, the categories may be divided by parts of speech. In addition, the grammar categories 212 of the grammar menu 210 may be divided into sub-categories, each of the sub-categories may be further divided. The items of the grammar categories 212 may be configured in a variety of ways.

The subject categories 222 divide subjects into several items. For example, the subject categories 222 may be divided into items by situations that are generally encountered in everyday life such as basic, living, nature, travel and food. Alternatively, the subject categories 222 may be divided into items by subject areas such as science, mathematics, history and fine art. In addition, the subject categories 222 may be divided into sub-categories, each of the sub-categories may be further divided. The items of the subject categories 222 may be configured in a variety of ways.

The quiz output window 230 is a window in which a quiz issued by the quiz module 200 is displayed to the user. The quiz may be output in the form of letters, or in some cases in the form of voice. The quiz module 200 may issue as a quiz a sentence in the natural language among the sentences stored in the database 100 of the server computer, which belongs to the grammar type and/or subject received through the grammar menu 210 and/or the subject menu 220 and has a grammatical error.

In addition, the quiz output window 230 may further include a difficulty level menu 232 and a refresh menu 234. The difficulty level menu 232 may be used to set the difficulty levels of quizzes to be presented. For example, when the user has not learned a language for a long period of time, she/he may set the difficulty level of quizzes to a low level. If the user does not set the difficulty level, the quiz module 200 may issue quizzes of random difficulty levels.

If the user has solved all of the quizzes presented in the quiz output window 230 or wants to solve another quiz, she/he may use the refresh menu 234 located in the quiz output window 230 so that another quiz is presented.

The answer input window 310 allows a user to input an answer by correcting an error in a quiz. The answer sheet module 300 may receive the user's answer to the quiz from the user device 2, i.e., the answer input window 310 in the form of letters and/or voice.

When the user uses letters, the user can input her/his answer to the answer input window 310 using an input device such as a keyboard and a handwriting recognizer.

On the other hand, when the user uses the voice, the user may input a voice answer to the answer input window 310 by using an input device such as a microphone.

The correct answer output window 410 shows correct answers to quizzes by the correction module 400. The correction module 400 corrects grammatical errors of the answers input by a user, if any, through the correct answer output window 410, and outputs the correct answers. In addition to the correct answers, the correction module may further present at least one of variations of a declarative sentence, interrogative sentence, imperative sentence, exclamatory sentence, negative expression, formal expression, tense, aspect, passive voice and active voice, and the grammar knowledge which is the basis of the answers.

The looks and locations of the menus shown in FIG. 2 are merely illustrative. Each menu may be presented as a single menu, or a single menu may be divided into two or more menus. In addition, the arrangement of each menu may also be modified from that shown in the drawings.

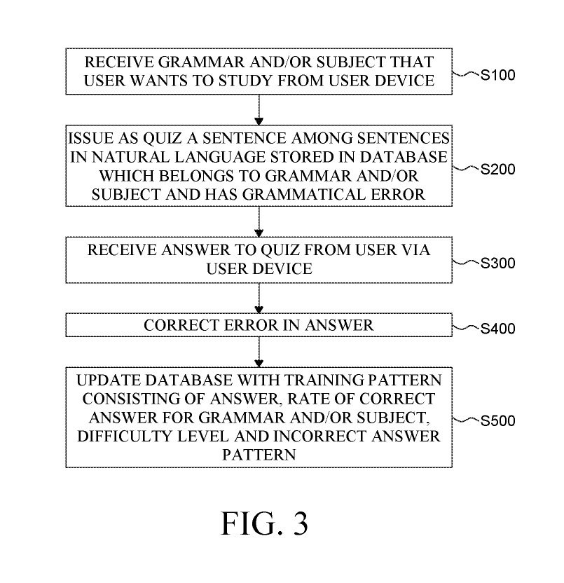

Hereinafter, a method for learning a language using the big data based language learning device 10 will be described with reference to FIGS. 3 to 4C, based on the big data based language learning device 10 described above with reference to FIGS. 1A to 1C and 2.

FIG. 3 is a flowchart for illustrating a method for learning a language using a big data based language learning device according to an exemplary embodiment of the present disclosure. FIG. 4A is a diagram showing an example of the screen in which a quiz module of a big data based language learning device according to an exemplary embodiment of the present disclosure receives a grammar type that a user wants to study from a user device and issues a quiz. FIG. 4B is a diagram showing an example of the screen in which a quiz module of a big data based language learning device according to an exemplary embodiment of the present disclosure receives a subject that a user wants to study from a user device and issues a quiz. FIG. 4C is a diagram showing an example of the screen in which a quiz module of a big data based language learning device according to an exemplary embodiment of the present disclosure receives a grammar type and a subject that a user wants to study from a user device and issues a quiz.

Initially, a big data based language learning device according to an exemplary embodiment of the present disclosure receives a grammar type and/or a subject from a user through a user device (step S100). Subsequently, the big data based language learning device issues to the user, as a quiz, a sentence in a natural language among the sentences stored in the database of ther server computer, which belongs to the grammar type and/or subject and has a grammatical error (step S200).

The quiz module 200 of the big data-based language learning device 10 may receive a grammar type and/or subject from the user device 2 by using letters and/or voice or by selecting a category, and may present the quiz belonging to the received grammar type and/or subject.

As described above with reference to FIG. 2, the quiz module 200 displayed to the user may include the grammar menu 210, the subject menu 220 and the quiz output window 230. The quiz module 200 may receive the grammar type and/or subject that the user wants to study through the grammar menu 210 and the subject menu 220. The user may choose a grammar type and/or subject that she/he wants to study at least one of by using letters, voice and a category. The using letters or voice or the selecting a category has been described above; and, therefore, the redundant description will be omitted.

In the following description with reference to FIGS. 4A to 4C, it is assumed that the user selects a category to choose a grammar type and/or subject that she/he wants to study, and that the quiz module 200 issues a quiz belonging to the grammar type and/or subject through the quiz output window 230.

Referring to FIG. 4A, when a user selects a grammar type that she/he wants to study from the grammar menu 210 by selecting the category, the quiz module 200 may present a sentence in the natural language as a quiz, which has a grammatical error associated with the grammar type selected by the user. For example, if the user selects the grammar categories 212 of “tense,” “future” and “will” of the grammar menu 210, the quiz module 200 may present the sentence that “I have starved until tomorrow” as a quiz from among the sentences in the natural language stored in the database 100 of the server computer, which is associated with the selected grammar categories 212 and has a grammatical error.

Referring to FIG. 4B, when a user selects a subject that she/he wants to study from the subject menu 220 by selecting the category, the quiz module 200 may present a sentence in the natural language as a quiz, which is associated with the subject selected by the user and has a grammatical error. For example, if the user selects the subject categories 222 of “travel,” “plan” and “schedule” from the subject menu 220, the quiz module 200 may present the sentence that “I am goinf to travel to the United States for two weeks” as a quiz from among the sentences in the natural language stored in the database 100 of the server computer, which is associated with the selected subject categories 222 and has a grammatical error. Since the grammar category 212 is not selected, the quiz module 200 may arbitrarily select a grammar type and issue a quiz with a grammatically error.

Referring to FIG. 4C, when a user selects a grammar type and a subject that she/he wants to study from the grammar menu 210 and the subject menu 220 by selecting the categories, the quiz module 200 may present a sentence in the natural language as a quiz, which is associated with the subject and has a grammatical error associated with the grammar type selected by the user. For example, if the user selects the grammar categories 212 of “tense,” “future” and “will” of the grammar menu 210 and the subject categories 222 of “travel,” “plan” and “schedule” of the subject menu 220, the quiz module 200 may present the sentence that “He started travel to Busan until tomorrow” as a quiz from among the sentences in the natural language stored in the database 100 of the server computer, which is associated with the selected grammar categories 212 and the subject categories 222 and has a grammatical error.

Subsequently, the big data based language learning device may receive an answer to the quiz from the user through the user device (step S300).

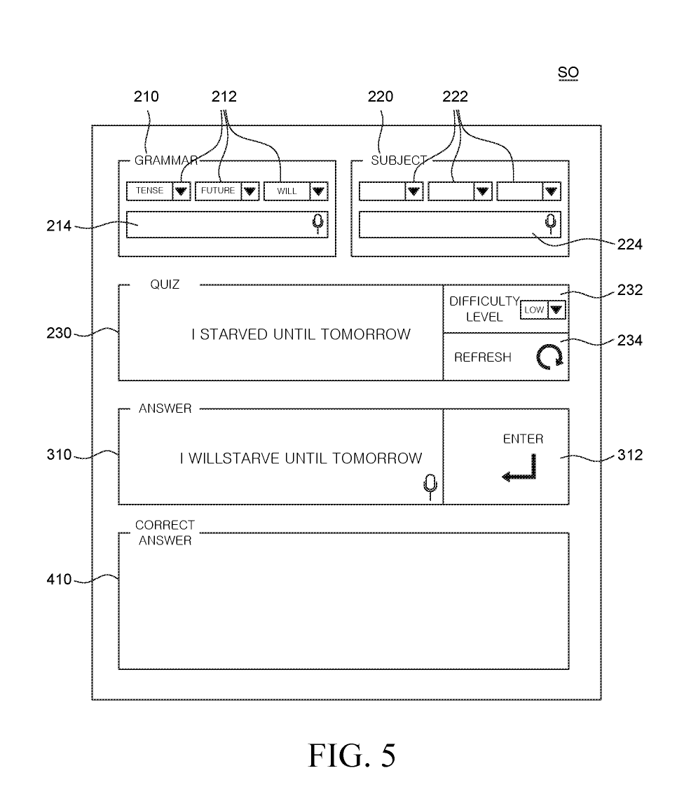

FIG. 5 is a diagram illustrating an example of the screen in which an answer sheet module of a big data based language learning device according to an exemplary embodiment of the present disclosure receives an answer.

Referring to FIG. 5, the answer sheet module 300 of the big data based language learning device 10 may receive the answer to the quiz from the user device 2 in the form of letters and/or voice. For example, the answer sheet module 300 may receive an answer from a user through the answer input window 310 of the screen of the user device 2. Specifically, the user may find a grammatical error in the quiz presented in the quiz output window 230 and may correct the grammatical error to input the answer in the answer input window 310. Once the answer has been input, the user may press the Enter key of the keyboard or the input button 321 to deliver the answer to the answer sheet module 300.

For example, let us assume that the quiz that “I starved until tomorrow” is issued in the quiz output window 230. The user may find the grammatical error from the sentence that the tense of “tomorrow” does not match with the tense of “starved.” Then, the user may correct the grammatical error of the quiz and input the answer that “I will starve until tomorrow” into the answer input window 310. Once the user has input the answer, she/he may press the Enter key or the input button 312 to send the answer to the answer sheet module 300. Subsequently, the answer sheet module 300 may receive the answer input to the answer input window 310 and may deliver the answer to the correction module 400.

Subsequently, the big data based language learning device may correct an error in the answer, if any, and output a correct answer (step S S400).

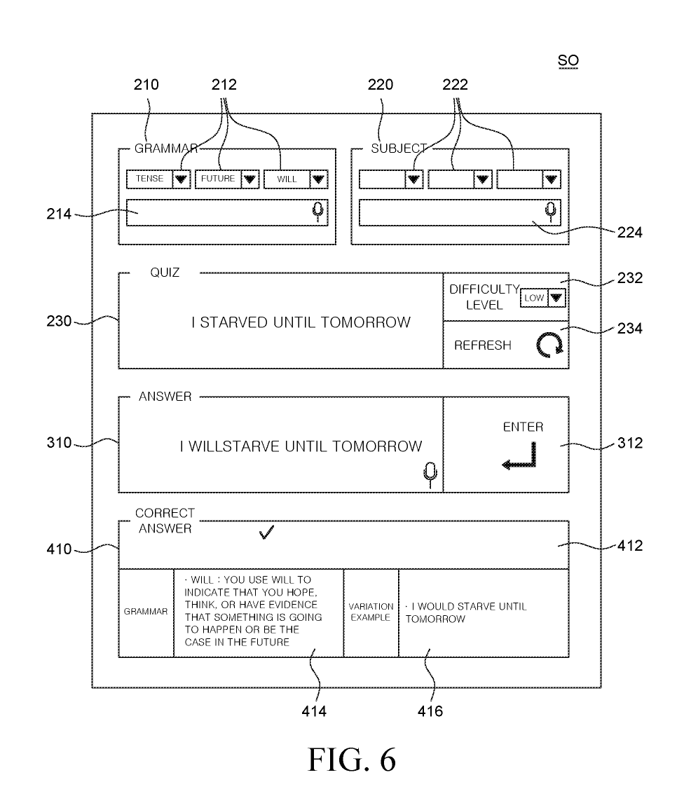

FIG. 6 is a diagram illustrating an example of the screen in which a correction module of a big data based language learning device according to an exemplary embodiment of the present disclosure corrects an error in an answer and outputs a correct answer, grammar knowledge and variations.

Referring to FIG. 6, if the answer has a grammatical error, the correction module 400 of the big data based language learning device 10 may correct the grammatical error in the answer to output a correct answer. In addition to the correct answer, the correction module 400 may further output at least one of variations of a declarative sentence, an interrogative sentence, an imperative sentence, an exclamatory sentence, a negative expression, a formal expression, tense, aspect, passive voice and active voice, and the grammar knowledge which is the basis of the answer.

For example, let us assume that the quiz that “I starved until tomorrow” is presented in the quiz output window 230. If the user inputs the answer that “I willstarve until tomorrow” in the answer input window 310, the correction module 400 may correct the error of spacing of words, i.e., “willstarve” in the answer, to output the corrected answer that “I will starve until tomorrow” in the correct answer menu 412 of the correct answer output window 410. Additionally, the correction module 400 may further output the grammatical knowledge about the word “will” among grammatical knowledge necessary for deriving the correct answer in a grammar knowledge menu 414 of the correct answer output window 410. In addition, the correction module 400 may further output a variation example of the correct answer, i.e., “I would starve until tomorrow” in a variation example menu 416 of the correct answer output window 410.

There may be more than one correct answers, grammar knowledge pieces and variations for a single quiz. The correction module 400 may present more than one correct answers, grammar knowledge pieces and variations to the correct answer output window 410. It is to be understood that the drawings are illustrative and not restrictive.

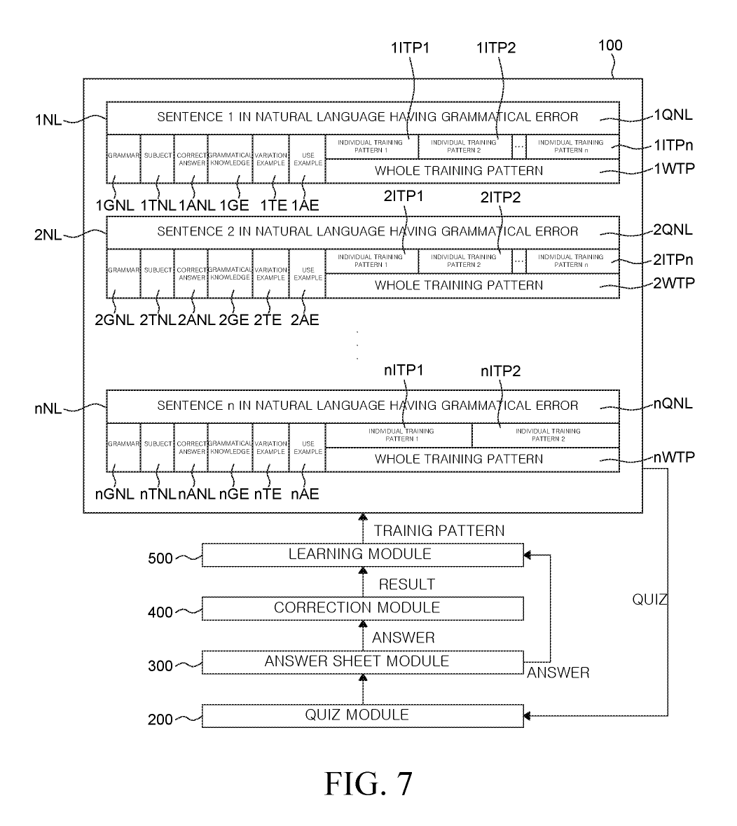

The big data based language learning device according to an exemplary embodiment of the present disclosure updates the database of the server computer with the training patterns consisting of the answers, the correct answer rates for each of the grammar types and/or subjects, the difficulty levels, and incorrect answer patterns (step S500). The manner of creating the training pattern is not particularly limited. For example, a training pattern may be created by making a grammar, a form and a subject included in a sentence in a natural language in a plurality of dimensions, expressing each sentence as a vector, and making a similar training pattern using a distance between the vectors and cosine similarity. Alternatively or subsequently, a training pattern may be created by predicting errors in a sentence in the natural language to be made by users. FIG. 7 is a diagram for illustrating a process of updating the database with training patterns by a learning module of a big data based language learning device according to an exemplary embodiment of the present disclosure.

Referring to FIG. 7, the learning module 500 of the big data-based language learning device 10 according to an exemplary embodiment of the present disclosure may classify an answer into a sentence in the natural language QNL having a grammatical error when the answer is an incorrect answer, to update the database 100 of the server computer with it. In addition, the learning module 500 may update the database 100 of the server computer with the individual training pattern ITP in which user's identification information 510 is included in the training pattern consisting of the correct answers, correct answer rates for each of the grammar types and/or subjects, difficulty levels, and incorrect answer patterns, based on the user's answer and the output result of the correction module 400. The identification information 510 may be personal information to identify users, such as users' names, telephone numbers and IDs. Also, the identification information 510 may be personal biometric information to identify users, such as user's fingerprints, iris, vein, voice and facial feature. In the following description, it is assumed that the user's identification information 510 includes IDs 510a and passwords 510b.

Specifically, only when the answer is an incorrect answer, the learning module 500 may classify the answer into a sentence in the natural language nQNL having a grammatical error, i.e., a quiz nQNL, and may update the database 100 of the server computer with it. Then, the learning module 500 may create a training pattern consisting of a correct answers nANL, grammar knowledge nGE, variation examples nTE, grammar nGNL and/or subject nTNL corresponding to the quiz, whether or not the answer is correct, the correct answer rate for the answer, the difficulty level according to the average correct answer rate, the user's incorrect answer pattern, and the user's answer displayed in the correct answer output window 410 by the correction module 400. Then, the learning module 500 may create the individual training patterns nITP1 and nITP2 by further including the user identification information 510 in the training pattern and update the database 100 of the server computer with it.

Referring to FIG. 7, the answer received by the answer sheet module 300 is sent to the correction module 400. The correction module 400 compares the answer with the correct answer nANL. The correction module 400 may send to the learning module 500 the results such as the correct answer nANL, grammar knowledge nGE, variation examples nTE, grammar nGNL and/or subject nTNL corresponding to the quiz, whether or not the answer is correct, the correct answer rate for the answer, the difficulty level according to the average correct answer rate, and the user's incorrect answer pattern. In addition, the learning module 500 may receive the answer from the answer sheet module 300 and the results from the correction module 400 to create a training pattern.

Subsequently, the learning module 500 may store the individual training patterns nITP1 and nITP2 that further include the user's identification information 510 in the training pattern in the database 100 of the server computer together with the sentence in the natural language nQNL having the grammatical error, i.e., the quiz nQNL. In addition, a plurality of individual training patterns nITP1 and nITP2 may be stored for a single sentence in the natural language according to each user's identification information 510 and each training pattern. It is to be understood that the number of the individual training patterns ITP is not limited herein.

In this way, the learning module 500 may update the individual training pattern nITP to the sentence in the natural language nNL consisting of a sentence in the natural language nQNL having a grammatical error, i.e., a quiz nQNL, a sentence in the natural language nANL having no grammatical error, i.e., the correct answer nANL, a grammar nGNL, a subject nTNL, grammar knowledge nGE corresponding to the quiz and the correct answer, variation examples nTE and usage examples nAE.

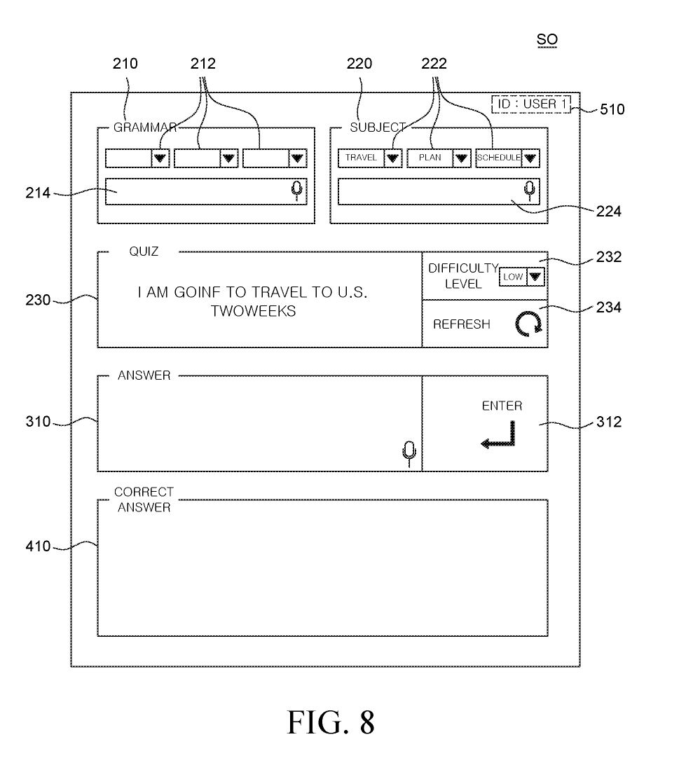

FIG. 8 is a diagram showing an example of the screen in which a quiz module of a big data-based language learning apparatus according to an exemplary embodiment of the present disclosure, issues a quiz based on a user's identification information and individual training pattern.

Referring to FIGS. 7 and 8, a process of issuing a quiz by the quiz module 200 of the big data based language learning device 10 according to an exemplary embodiment of the present disclosure after the individual training pattern ITP is updated in the database 100 will be described with reference to FIGS. 7 and 8.

Referring to FIG. 8, the quiz module 200 of the big data based language learning device 10 according to an exemplary embodiment of the present disclosure may issue a quiz by reflecting the grammar GNL and/or subject TNL at the difficulty level set by the user based on the individual training pattern ITP updated in the database 100 of the server computer. Specifically, when the user inputs her/his identification information into the screen SO of the application where the big data based language learning device 10 is implemented, quizzes are issued by reflecting the grammar type and/or subject that the user is weak, so that the user can learn the language efficiently.

Referring to FIG. 8, when the identification information 510 of User 1 is inputted, for example, the screen SO of the application where the big data based language learning device 10 is implemented may display that the identification information has been input. User 1 may select the subject categories 222 of travel, plan and schedule of the subject menu 220 and may set the difficulty level of the quiz to the low level. Subsequently, the quiz module 200 recognizes that User 1 has a low rate of correct answers in quizzes related to changes in form and spacing in the grammar, in the individual training pattern ITP of User 1. Thus, instead of issuing a sentence in the natural grammar with a random grammatical error as a quiz, the quiz module 200 may issue as quizzes sentences in the natural language QNL which is associated with the subject categories 222 selected by User 1 and has a grammatical error in terms of form and spacing. As a result, a quiz that “I am goinf to U.S. for twoweeks” may be displayed in the quiz output window 230, which has the error of spacing with difficulty level of low “twoweeks” and has the error of the change in the form with difficulty level of low “goinf.”

Learning a new language requires comprehensive learning including reading, listening, writing and speaking the language. If a person studies a phonogram only by reading it, she/he may be able to pronounce it but may not be able to understand the meaning of the language, write or listen the language. Thus, the person would not be able to learn and use the language. In addition, different educators and students have different opinions on how and where to learn a language. And, even if a person starts learning a language, it is very difficult to determine which situation or which grammar to start with, since the range of the language, i.e., the field that the language expresses, is so broad.

In view of the above, the big data based language learning device 10 according to an exemplary embodiment of the present disclosure and the method for learning a language using the same may allow a user who learns a language to select a particular grammar type and/or subject that she/he wants to study. Specifically, a user can learn a language efficiently because the user can study only a particular grammar quiz, a quiz on a particular subject, or a quiz on a particular grammar and a particular subject.

In addition, the big data based language learning device 10 and the method for learning a language using the same according to an exemplary embodiment of the present disclosure can determine the individual training pattern ITP for each of the users to facilitate the users to learn the language efficiently. Different users have different weak points in learning a language. A user may be weak at the grammar of formal expressions. Another user may be weak at the grammar of tense. Yet another user may be weak at the subject of meal. In this case, the quiz module 200 recognizes that one user is weak in the grammar of the formal expressions from the individual training pattern ITP and may issue sentences in the natural language having grammatical errors of the formal expressions more frequently. As such, in the big data based language learning device 10 and the method for learning a language using the same according to an exemplary embodiment of the present disclosure, it is possible to adaptively issue quizzes so that the user can study weak points first based on the user's individual training pattern ITP.

Therefore, the big data based language learning device 10 and the method for learning a language using the same according to an exemplary embodiment of the present disclosure allows a user to learn a natural language from a part that she/he wants to study or a part that she/he is weak, so that the user can learn the natural language quickly and efficiently.

Incidentally, a natural language may include a basic form as well as many variations from the basic form. For example, there are many variations in greetings, such as “hello,” “hi,” “nice to meet you, ” “it's been a while, ” “how have you been, ” “good morning” and “welcome.” In addition, since different natural languages have different cultures, different grammars and different word orders, it is also important to learn accurate grammar knowledge when learning natural languages.

In view of the above, the big data based language learning device 10 according to an exemplary embodiment of the present disclosure and the method for learning a language using the same may provide not only correct answers but also variation examples, as well as grammar knowledge. Therefore, as a user solves a quiz, she/he can also learn the grammar knowledge, the correct answer, and the variation examples of the correct answer all together, so that the language can be easily expanded and learned.

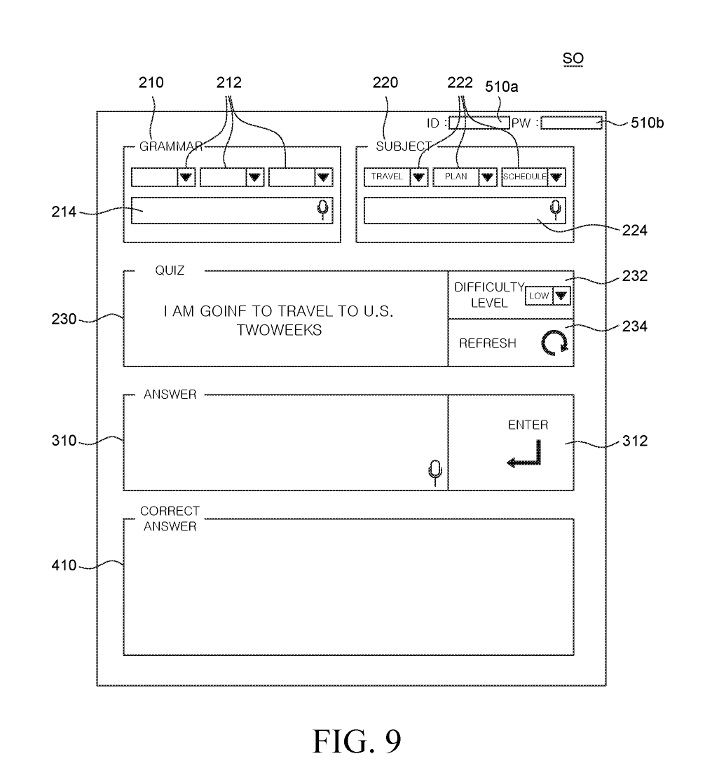

FIG. 9 is a diagram showing an example of the screen in which a quiz module of a big data based language learning device according to another exemplary embodiment of the present disclosure issues a quiz based on a whole training pattern.

The learning module 500 of the big data-based language learning device 10 according to another exemplary embodiment of the present disclosure may update the database 100 with the whole training pattern WTP consisting of the average rate of correct answers according to each of the grammar types and/or subjects, the average difficulty level and the average incorrect answer pattern based on the individual training pattern ITP of each of the users. If no user identification information 510 is received in the quiz module 200, the quiz module 200 may issue a quiz by reflecting the grammar type and/or subject of the average difficulty level corresponding to the difficulty level set by a user based on the whole training pattern WTP updated in the database 100 of the server computer.

Referring to FIGS. 7 and 9, the learning module 500 of the big data based language learning device 10 according to another exemplary embodiment of the present disclosure may create, from the individual training patterns ITP of several users, a whole training pattern WTP consisting of the answer included in each of the individual training patterns ITP, the correct answer rate for the grammar type and/or subject, the average correct answer rate according to the grammar type and/or subject of sentences in the natural language from the difficulty level and incorrect answer pattern, the average difficulty level and the average incorrect answer pattern, to update the database 100 of the server computer with it.

For example, since n individual training patterns lITP1 to lITPn are stored for a first natural language 1NL, the learning module 500 may create the whole training pattern 1WTP from the n individual training patterns 1ITP1 to 1ITPn. For example, since two individual training patterns nITP1 and nITP2 are stored for an n^{th} natural language nNL, the learning module 500 may create the whole training pattern nWTP from the two individual training patterns nITP1 and nITP2. If one individual training pattern ITP is stored for a natural language, the individual training pattern ITP may be identical to the whole training pattern WTP. If a new individual training pattern ITP is stored for a natural language, the whole training pattern WTP may also be updated accordingly.

Subsequently, referring to FIG. 8, after the whole training pattern WTP has been updated in the database 100 of the server computer, if an anonymous user whose identification information 510 is not registered wants to use the big data based language learning device 10 according to another exemplary embodiment of the present disclosure to learn a language, the quiz module 200 may issue a quiz by reflecting the grammar type and/or subject having the average difficulty level corresponding to the difficulty set by the anonymous user based on the whole training pattern WTP.

For example, while the ID 510a and the password 510b are not input to the identification information 510, an anonymous user may select the subject categories 222 of the subject menu 220 of travel, plan and schedule, and may set the difficulty level to the low level, so that a quiz is issued. The quiz module 200 may issue a sentence in the natural language as a quiz, which is associated with a subject selected by the user and has the grammatical error “I am goinf to travel to U.S. for twoweeks” of the average difficulty level of low selected by the user.

Accordingly, in the big data based language learning device 10 and the method for learning a language using the same according to another exemplary embodiment of the present disclosure, the average correct answer rate, the average difficulty level and the average incorrect answer pattern for each of the grammar types and/or subjects may be detected from each of the individual training patterns ITP of all of the users to update the database 100 of the server computer with the whole training pattern WTP. Accordingly, even if there is no identification information 510 and the individual training pattern ITP for a user, it is possible to issue a quiz with the average difficulty level corresponding to the difficulty level set by the user based on the whole training pattern WTP or may issue a quiz that the user is weak. Therefore, in the big data based language learning device 10 according to another exemplary embodiment of the present disclosure, the whole training pattern WTP in which the average correct answer, the average difficulty level, and the average incorrect pattern are stored from the individual training patterns ITP obtained from the entire users may be detected, and a quiz belonging to the grammar type and/or subject of the difficulty level that the user wants to learn may be issued based on the whole training pattern WTP.

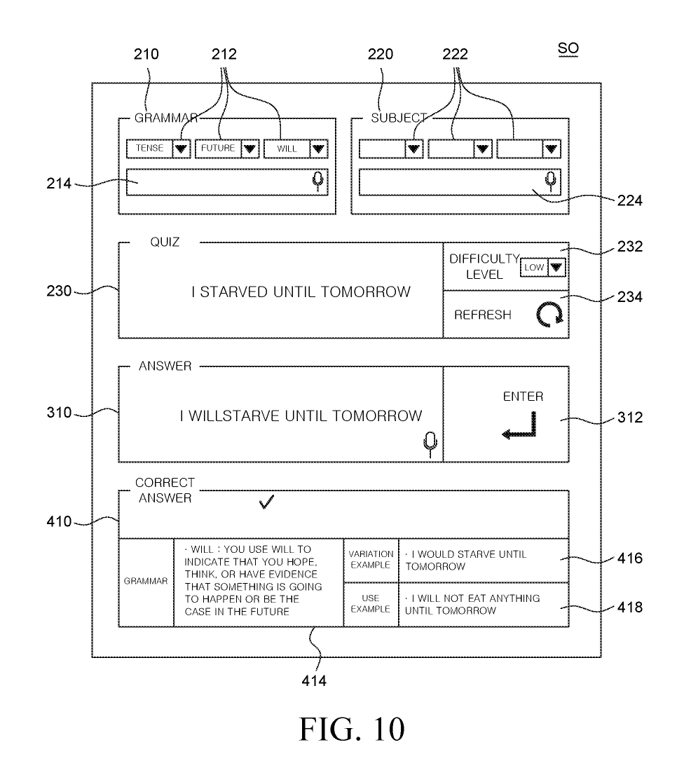

FIG. 10 is a diagram illustrating an example of the screen in which a correction module of a big data based language learning device according to yet another exemplary embodiment of the present disclosure corrects an error in an answer and outputs a correct answer, grammar knowledge, variations and usage examples.

The correction module 400 of the big data based language learning device 10 according to yet another exemplary embodiment of the present disclosure further outputs usage examples of a correct answer used in the real life such as the Internet or broadcast media. Such usage examples may include colloquial expressions, newly coined words, jargons, Internet slangs, buzzwords, foreign words. The server computer updates the database with usage examples received from another server computer. For example, the another server computer may be a server computer that runs an Internet search site or broadcast site.

Referring to FIG. 10, the correction module 400 of the big data-based language learning device 10 according to yet another exemplary embodiment of the present disclosure may further output usage examples of a correct answer used in the real life such as the Internet or broadcast media in the correct answer window 410, as well as correct answer, the grammar knowledge and variation examples. The processes of issuing a quiz when a user selects a grammar type that she/he wants to study, inputting an answer and outputting a correct answer, a grammar knowledge and variation examples are identical to those described above with reference to FIGS. 4A to 6.

For example, the correction module 400 may output a correct answer to a quiz in the correct answer menu 412 of the correct answer output window 410, may output the grammar knowledge of “will” in the grammar knowledge menu 414 which is required to derive the correct answer, and may output the variation example that “I would starve until tomorrow” in the variation example menu 416, which is one of the variation examples of the correct answer. Then, the correction module 400 may output an usage example of the correct answer that “I will not eat any thing until tomorrow” in the usage example menu 418 of the correct answer output window 410, which is a colloquial usage example used in the real life.

Further, in some exemplary embodiments, the correction module 400 may further output conjugations of verbs as usage examples of a correct answer. The conjugations of verbs refer to how a verb changes to show a different person, tense, number or mood. Because there are so many conjugations of a verb, a user may find it difficult to use the conjugations.

Accordingly, the correction module 400 may further output conjugations of a verb as usage examples of a correct answer. Such usage examples may include inflections of a verb for person, number, tense, voice, mood, etc. For example, when a correct answer that “I listen to music” is output in the correct answer output window 410, the usage example menu 418 may output conjugations of the verb “listen” of the correct answer, i.e., “listens,” “listened,” “will listen,” “want to listen,” “can listen”, etc.

In this manner, the big data-based language learning device 10 and the method for learning a language using the same according to yet another exemplary embodiment of the present disclosure provide a user with a correct answer of a quiz, a grammar knowledge for deriving the correct answer and variation examples of the correct answer, so that the user can easily expand and learn the natural language. In addition, examples of the natural language used in the real life are provided, so that the user can learn not only grammar, reading and writing, but also speaking. Therefore, the big data based language learning device 10 and the method for learning a language using the same according to yet another exemplary embodiment of the present disclosure allows a user to learn a natural language comprehensively including reading, writing and speaking, so that the user can learn the natural language quickly and efficiently.

Herein, the blocks or the steps may represent portions of modules, segments or codes including one or more executable instructions for performing specific logical function(s). In addition, it should be noted that, in some alternative embodiments, the functions described in association with blocks or steps may be performed out of a specified sequence. For example, two consecutive blocks or steps may be performed substantially simultaneously or may be performed in the reverse order depending on the function to be performed.

The steps of the method or the algorithm described with respect to the exemplary embodiments of the present disclosure may be implemented in hardware or as a software module executed by a processor, or as a combination thereof. The software module may reside on a RAM memory, a flash memory, a ROM memory, an EPROM memory, an EEPROM memory, a register, a hard disk, a removable disk, a CD-ROM or any storage medium known in the art. An example storage medium may be coupled with a processor, and the processor may read/write information out of/onto the storage medium. Alternatively, the storage medium may be integrated with the processor. The processor and the storage medium may reside in an application-specific integrated circuit (ASIC). The ASIC may reside in a user terminal as well. Alternatively, the processor and the storage medium may reside in a user terminal as separate components.

Thus far, exemplary embodiments of the present disclosure have been described in detail with reference to the accompanying drawings. However, the present disclosure is not limited to the exemplary embodiments, and modifications and variations can be made thereto without departing from the technical idea of the present disclosure. Accordingly, the exemplary embodiments described herein are merely illustrative and are not intended to limit the scope of the present disclosure. The technical idea of the present disclosure is not limited by the exemplary embodiments. Therefore, it should be understood that the above-described embodiments are not limiting but illustrative in all aspects. The scope of protection sought by the present disclosure is defined by the appended claims and all equivalents thereof are construed to be within the true scope of the present disclosure.

What is claimed is:

1. A big data based language learning device comprising:
a database of a server computer in which sentences in a natural language are stored, the sentences consisting of ones having a grammatical error and ones having no grammatical error;
a quiz module configured to receive a grammar type and/or a subject that a user wants to study from an input device that are connected a user device either wired or wireless, or that are built into the user device, to provide the grammar type and/or the subject to the server computer, the quiz module is further configured to receive a sentence among the sentences in the natural language stored in the database, the sentence corresponds to the received grammar type and/or the subject, the sentence includes the grammatical error, and the quiz module is further configured to issue the sentence as a quiz on a display of the user device;
an answer sheet module configured to receive an answer to the quiz from the input device of the user device;
a correction module configured to receive a sentence among the sentences in the natural language stored in the database of the server computer, the sentence corresponds to the received grammar type and/or the subject and the sentence includes no grammatical error, the correction module further configured to compare the answer with the sentence including no grammatical error, and the correction module further configured to correct an error in the answer; and
a learning module configured to update the database of the server computer with a training pattern consisting of the answer, a rate of correct answer for the grammar type and/or the subject, a difficulty level and an incorrect answer pattern,
wherein the quiz module outputs a next quiz based on the training pattern updated in the database by the learning module, and
wherein the input device comprises at least one of a mouse, a touch pad, a touch screen, a keyboard, a handwriting recognizer, and a microphone.

2. The device of claim 1, wherein the sentences in the natural language stored in the database further comprises at least one of variations of a declarative sentence, an interrogative sentence, an imperative sentence, an exclamatory sentence, a negative expression, a formal expression, tense, aspect, passive voice and active voice of the sentences.

3. The device of claim 1, wherein the quiz module receives the grammar type and/or the subject from the input device of the user device by using letters that are entered by the keyboard or the handwriting recognizer, by using voice that is entered by the microphone, and/or by selecting a category that is selected by the mouse, the touch pad or the touch screen, provides the grammar type and/or the subject from the user device to the server computer, and issues the quiz belonging to the received grammar type and/or the subject.

4. The device of claim 1, wherein the answer sheet module receives the answer to the quiz from the user device by using letters that are entered by the keyboard or the handwriting recognizer or by using voice that is entered by the microphone, and provides the answer to the correction module.

5. The device of claim 1, wherein the correction module receives a sentence among the sentences in the natural language stored in the database of the server computer, the sentence corresponds to the grammar type and/or the subject and the sentence has no grammatical error, the correction module stores the sentence as a correct answer, compares the answer with the correct answer, and corrects the grammatical error in the answer, if any, to output a correct answer, and
wherein the correction module further outputs at least one of variations of a declarative sentence, an interrogative sentence, an imperative sentence, an exclamatory sentence, a negative expression, a formal expression, tense, aspect, passive voice and active voice of the correct answer, and a grammatical knowledge that is basis of the correct answer received from the database of the server computer, together with the correct answer.

6. The device of claim 5, wherein the server computer updates the database with usage examples of the correct answer used in real life such as the Internet or broadcast media received from another server computer,
wherein the correction module further receives usage examples of the correct answer used in real life such as the Internet or broadcast media, and outputs the usage examples on the display of the user device, and
wherein the usage examples comprise colloquial expressions, newly coined words, jargons, Internet slangs, buzzwords and foreign words of the correct answer.

7. The device of claim 1, wherein if the answer is incorrect, the learning module classifies the answer into a sentence in the natural language having the grammatical error to update the database of the server computer with it,
wherein the learning module updates the database of the server computer with individual training pattern based on the user's answer and results from the correction module, the individual training pattern comprising the answer, the rate of correct answers for the grammar type and/or subject, the average difficulty level and the incorrect answer pattern together with the user identification information,
wherein if the user identification information is received in the quiz module through the input device of the user device, wherein the quiz module receives the individual training pattern updated in the database of the server computer, issues the quiz by reflecting the grammar type and/or subject of the difficulty level set by the user based on the individual training pattern updated in the database of the server computer, and
wherein the user identification information comprises at least one of the user's names, telephone numbers, IDs, fingerprints, iris, vein, voice and facial feature.

8. The device of claim 7, wherein the learning module receives an individual training pattern of each of users from the database of the server computer, generates a whole training pattern consisting of an average rate of correct answers for the grammar type and/or the subject, an average difficulty level and an average incorrect answer pattern based on an individual training pattern of each of users, and updates the database of server computer with the whole training pattern, and
wherein if no user identification information is received in the quiz module through the input device of the user device, the quiz module receives the whole training pattern updated in the database of the server computer, issues the quiz by reflecting the grammar type and/or subject of the average difficulty level corresponding to a difficulty level set by a user based on the whole training pattern.

9. A method for learning a language based on big data, the method comprising:
receiving a grammar type and/or subject that a user wants to study from a input device of a user device;
issuing as a quiz a sentence among sentences in a natural language stored in a database of a server computer that belongs to the grammar type and/or the subject and has a grammatical error on a display of the user device;
receiving an answer to the quiz from the user through the input device of the user device;
correcting an error in the answer based on a sentence among sentences in a natural language stored in the database of the server computer, the sentence corresponds to the quiz and has no grammatical error; and
updating the database of the server computer with a training pattern consisting of the answer, a rate of correct answer for the grammar type and/or the subject, a difficulty level and an incorrect answer pattern,
wherein the issuing the quiz comprises issuing a next quiz based on the training pattern updated in the database.
